(19) United States
(12) Patent Application Publication
(10) Pub. No.: US 2017/0063751 A1
(43) Pub. Date: Mar. 2, 2017

(54) SYSTEMS AND METHODS FOR GENERATING AND TRANSMITTING AN EMAIL MESSAGE INCLUDING AN ACTIVE CONTENT

(71) Applicant: Nicolas Korboulewsky-Braustein, Sofia (BG)

(72) Inventor: Nicolas Korboulewsky-Braustein, Sofia (BG)

(21) Appl. No.: 14/838,364

(22) Filed: Aug. 27, 2015

(51) Int. Cl. H04L 12/58

(52) U.S. Cl. CPC H04L 51/08; H04L 51/18

(57) ABSTRACT

A system and method for generating and transmitting an email message that includes an active content. The active content may be one or more user interfaces describing a unique instance of a software application. The system may include one or more hardware processors configured by machine-readable instructions to obtain the one or more user interfaces to be transmitted by the email message. The one or more hardware processors may be configured to attach access information to the email message. The access information may be configured to facilitate access to a rendering server. The rendering server may be configured to render the one or more user interfaces being transmitted by the email message in a format that is compatible with a receiving email client.

### FIELD OF THE DISCLOSURE

The present invention relates to systems and methods for creating and sending dynamic content via electronic messaging.

### BACKGROUND

Email is a service of exchanging written messages and documents sent electronically over computer networks. Email is one of the oldest network services that predates the World Wide Web which democratized the Internet network. Originally, Email was in form of a document that had only ASCII text (American Standard Code for Information Interchange). Regional encoding systems extended the characters sets. UTF-8 (Unicode Transformation Format) is used to solve problems related to different character sets which make the email difficult to read sometimes.

To overcome Email limitation of sending only text messages, MIME (Multipurpose Internet Mail Extensions) was invented. MIME allowed sending attached files. However, these days Email is used for much more than just sending simple text messages. For example, Email is being used to send complex layout with pictures. Hypertext markup language (HTML) format is used to provide rich text capabilities. Generally, HTML format is supported by the email client rendering engine. However, there is no clear standard on how to render the HTML format into the email client. How the HTML email will be rendered when the HTML becomes complex remains unpredictable.

The usage of email is much more used than before, but suffers from limitations related to the legacy of its older technology and use. In a corporate context, the email client software is widely used. One of the main weaknesses of the email is the difficulty to certify the email sender or the sending organization. The protocol used to send an email: SMTP (Simple Mail Transfer Protocol) allows sending messages without authentication. Even when extensions like SMTP AUTH (RFC 3207) exist, identity theft is still easy on email. This weakness allows a lot of bad usage of email like SPAM or SCAM. Because Email is a push system, it's often used by other software as a notification system that sometimes (if the application is for example a web application) includes a hyperlink to perform the operation requested by the notification.

### SUMMARY

Exemplary implementations of the disclosure may overcome the limitations presented above by providing a system and method for transmitting a dynamic secured content in the body of the email without changing the existing infrastructure of exchanging email namely the sending server using SMTP protocol and the post office server using POP3 (Post Office Protocol) or IMAP4 (Internet Message Access Protocol) or other protocols. The invention also works with actual RFCs (Request for Comments) describing the content of email and more particularly the MIME extensions.

One or more aspects of the disclosure relate to a system for generating and transmitting an email message that includes an active content. The active content may refer to one or more user interfaces describing a unique instance of a software application. The system may include one or more hardware processors configured by machine-readable instructions to obtain one or more user interfaces to be transmitted by the email message. The one or more hardware processors may be configured to attach access information to the email message. The access information may be configured to facilitate access to a rendering server. The rendering server may be configured to render the one or more user interfaces being transmitted by the email message in a format that is compatible with a receiving email client. The one or more hardware processors may be configured to generate a header for the email message. The header may include a unique identifying token. The unique identifying token may be a unique identifier associated with the unique instance of the user interface being transmitted. The one or more hardware processors may be configured to transmit the email message to the receiving email client. The receiving email client may be configured to connect to the rendering server, responsive to receiving the email message, using the access information included in the email message. The rendering server may be configured to render the one or more user interfaces in a format that is compatible with the receiving email client.

One or more aspects of the disclosure relate to a method for generating and transmitting an email message including an active content. In some implementations, the active content may refer to one or more user interfaces describing a unique instance of a software application. The method may be implemented in a system including one or more hardware processors configured by machine-readable instructions to execute the method. The method may include obtaining the one or more user interfaces to be transmitted by the email message. The method may include attaching access information to the email message. The access information may be configured to facilitate access to a rendering server. The rendering server may be configured to render one or more user interfaces being transmitted by the email message in a format that is compatible with a receiving email client. In some implementations, the method may further include generating a header for the email message. The header may include a unique identifying token. The unique identifying token may be a unique identifier associated with the one or more user interfaces being transmitted. The method may further include transmitting the email message to the receiving email client. The receiving email client may be configured to connect to the rendering server, responsive to receiving the email message, using the access information included in the email message. The rendering server may be configured to render the one or more user interfaces in a format that is compatible with the receiving email client.

These and other features and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular forms of “a”, “an”, and “the” include plural referents unless the context clearly dictates otherwise.

### BRIEF DESCRIPTION OF THE DRAWINGS

FIG. 1 illustrates a system 100 for generating and transmitting an email message including an active content, in accordance with one or more implementations.

FIG. 2 illustrates an example of structure of an EAC email, in accordance with one or more implementations.

FIG. 3 illustrates global transmission of an EAC email via standard email infrastructure, in accordance with one or more implementations.

FIG. 4 illustrates a rendering process of the user interface, in accordance with one or more implementations.

FIG. 5 illustrates a processing flow diagram by the EAC software, in accordance with one or more implementations.

FIG. 6 illustrates an authentication process before rendering process, in accordance with one or more implementations.

FIG. 7 illustrates external processing of EAC emails, in accordance with one or more implementations.

FIG. 8 illustrates EAC email content, in accordance with one or more implementations.

FIG. 9 illustrates a method for generating and transmitting an email message including an active content, in accordance with one or more implementations.

### DETAILED DESCRIPTION

The present disclosure describes a system 100 configured for creating and transporting an email that encapsulates a serialized active content readable in email client software with the needed function to decode and render the active content natively or by software extension like plug-in. The operations of the system may include defining the user interfaces of the active content in the form of a hierarchical description language such as XML (Extensible Markup Language). The hierarchical structure of the highest level may encapsulate the dynamic content with the needed attributes allowing contact with the server that processes the user events and generates the new user interface. The operations of system 100 may include generating an email message including the encapsulated dynamic content and with a specific MIME type that encapsulates it (e.g., multipart/mixed).

The operations of system 100 do not require use of a particular technology for a logic server processing, as long as the logic server is accessible via the Internet standard protocol (e.g., HTTP), and the logic server is able to process the conversion of the serialized User Interface.

The present disclosure describes a new paradigm of user interfaces of software applications transmitted by email and using the email client software to run the applications. The new technology that allows the new paradigm is referred to here as EAC (Email Active Content). This new paradigm may be equivalent in the spirit to already existing paradigms: Desktop applications where the client is a software running on an operating system for a device that is a desktop computer; Mobile applications where the client is running on a mobile device; and Web Applications where the client is a Web Browser that run the user interface generated by the server.

In some implementations, the email carries an abstract description of the initial user interface of the application (encoded as an example with XML). The user interface may be rendered into a usable interface fully integrated into the email client software. The EAC processor software may be either inside or outside the email client software, in the latter case the external software may connect to the email server that allows reading and modifying the email with the appropriate protocol (e.g., IMAP4). In some implementations, the EAC processor may be part of the email client. The EAC processor may be either embedded in the native code of the application or developed as Plug-In (e.g., Microsoft Outlook) able to replace the email rendering component of the client to fully support all features of the EAC email. The solution that does not allow a full rendering of EAC email will be referred to here as “EAC Lite”. A solution that allows a full featured rendering process will be referred to here as “EAC Full”. If the user does not have any active EAC processing solution for the user email client, the EAC email sent may include an alternative message authorized by a MIME multipart/mixed encoding (e.g., MIME type text/html) including a message with an explanation about the nature of the email and a link to a web application that allows seeing the EAC embedded content. The EAC email generator may define a clear process for the user to either activate the capability to process EAC email or to read it via an external link.

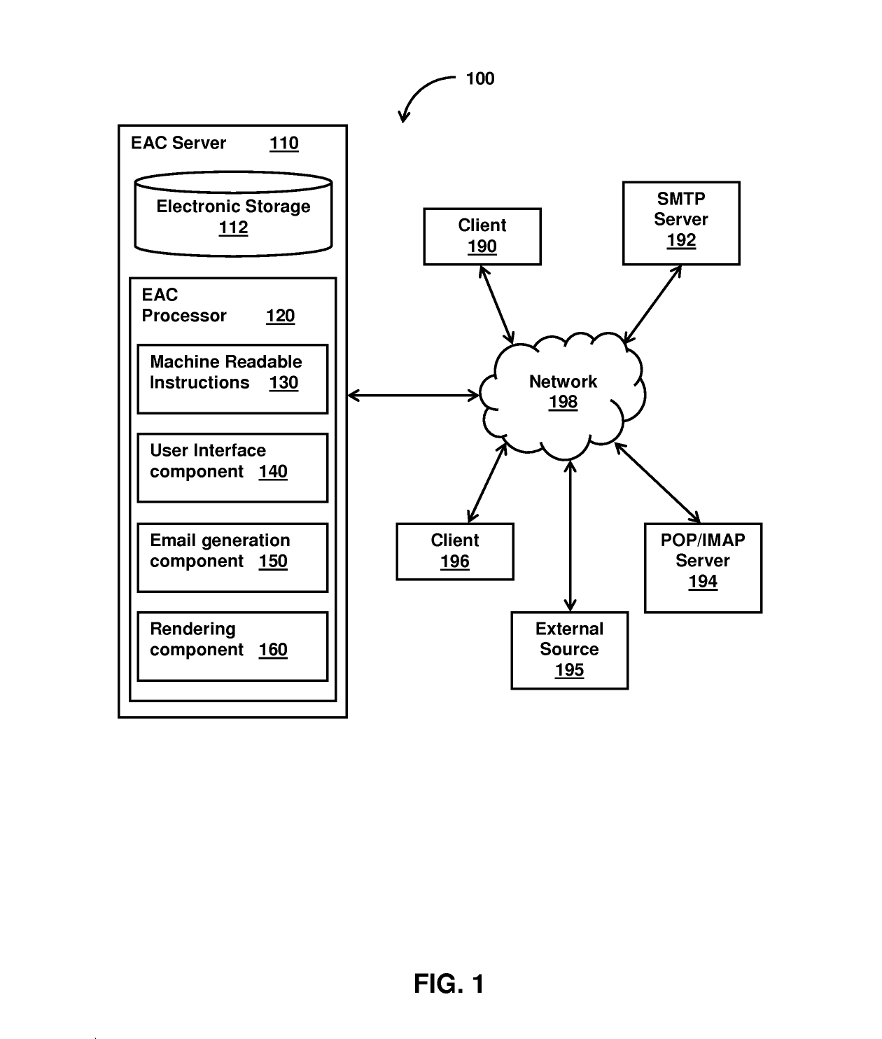

FIG. 1 illustrates a system 100 for generating and transmitting an email message including an active content, in accordance with one or more implementations. In some implementations, as shown in this example, system 100 may include one or more of EAC server 110, client 190, SMTP server 192, POP/IMAP server 194, client 196, network 198, and/or other components.

Email active content (EAC) server 110 may include electronic storage 112, one or more EAC processors 120, and/or other components. EAC processor(s) 120 may be configured by machine-readable instructions 130. The machine-readable instructions 130 may include one or more of a user interface component 140, an email generation component 150, a rendering component 160, and/or other components. User Interface component 140 may be configured to obtain one or more user interfaces describing a unique instance of the software application. The one or more user interfaces may be configured to be transmitted by the email message. In some implementations, the active content may include one or more of text, pictures, user interfaces of software applications, content that can change over time, and/or other active content. By way of non-limiting example, when a document is sent by email in a conventional way, it can be read by Email clients (e.g., Gmail, Yahoo, etc.), if using EAC Technology the document may be accessed, using an EAC server, via a User Interface to a local storage without being transmitted by email and then keep the email content confidential. Other examples of active content may include (Read once Self destructible email, collaborative work on document, up-to-date reports, in email secured payment, or up-to-date parcel tracking email).

Email generation component 150 may be configured to generate an email message including the active content. The email message may be generated in response to use-interactions with the user interface. The email message may include a header. Individual messages have individual headers structured into one or more fields. Individual fields have a name and a value. For example, internet standard RFC 5322 defines header fields. In some implementations, field names and values may be represented using 7-bit ASCII (American Standard Code for Information Interchange) characters, MIME encoding words if the values are Non-ASCII, UTF-8 (Unicode Transformation Format) characters, and/or other characters. In some implementations, the header may include a unique identifying token field. The unique identifying token may be a unique identifier associated with the one or more user interfaces being transmitted.

In some implementations, the one or more fields may include an instructions field. The instructions field may have one or more instructions. The one or more instructions may be configured to provide instructions associated with the unique identifying token to the rendering server. In some implementations, the instructions may include an instruction “new” informing the rendering server that the instance of the one or more user interfaces included in the email message is a new instance. In some implementations, the one or more instructions may include an instruction “update” instructing the rendering server to update the instance of the one or more user interfaces sent by email attached to the EAC software application identified by the unique token with the instance included in the email message. In some implementations, the one or more instructions may include an instruction “delete” instructing the rendering server to delete the instance of the one or more user interfaces sent by email attached to the EAC software application identified by the unique token.

In some implementations, the email component may be configured to attach access information to the email message. The access information may be configured to facilitate access to a rendering server. The rendering server may be configured to render the one or more user interfaces being transmitted by the email message in a format that is compatible with a receiving email client.

In some implementations, the email message may include a digital signature to preserve the integrity of the content from external manipulation and provide information related to the origin of the email. For example, a valid digital signature may confirm that the message was created by a known sender, may confirm the sender cannot deny having sent the message, may confirm that the message was not manipulated in transit, and/or may provide other information. In some implementations, a digital signature may be an authentication mechanism that enables the creator of the message to attach a code that acts as a signature, and to demonstrate the authenticity of the email message. In some implementations, a digital signature scheme may consist of a key generation algorithm, a signature generation algorithm, a signature verification algorithm. The key generation algorithm may select a private key randomly from a set of possible private keys. The signing algorithm may produce a signature given a message and a private key. The signature verification algorithm may accept or reject the authenticity of the message given the message, the public key and the signature.

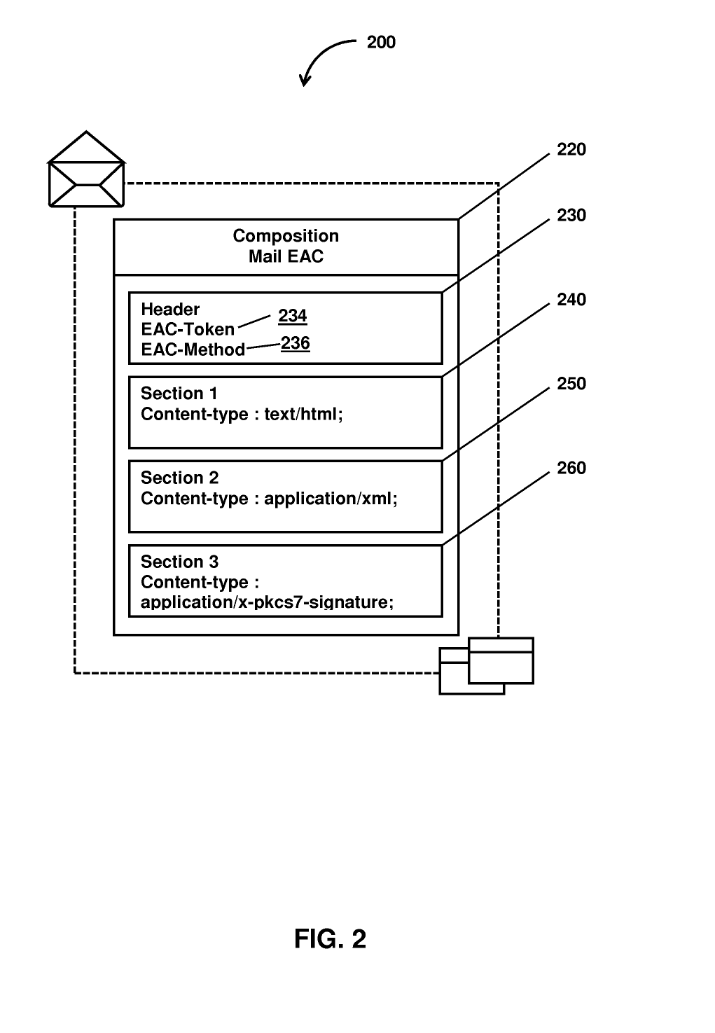

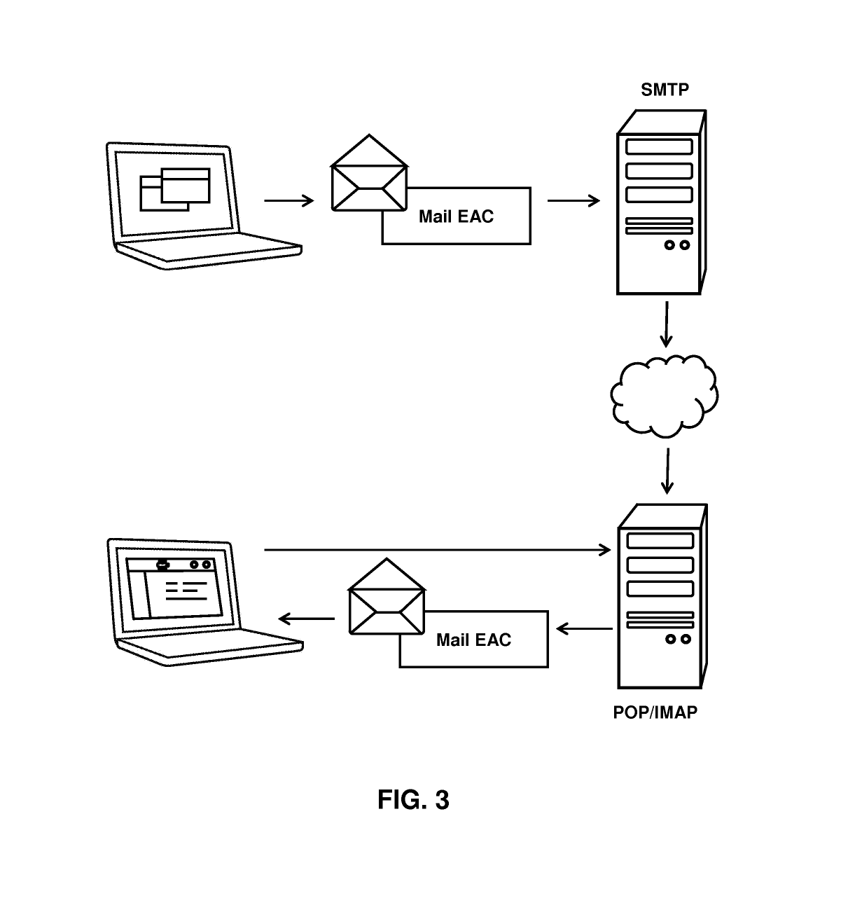

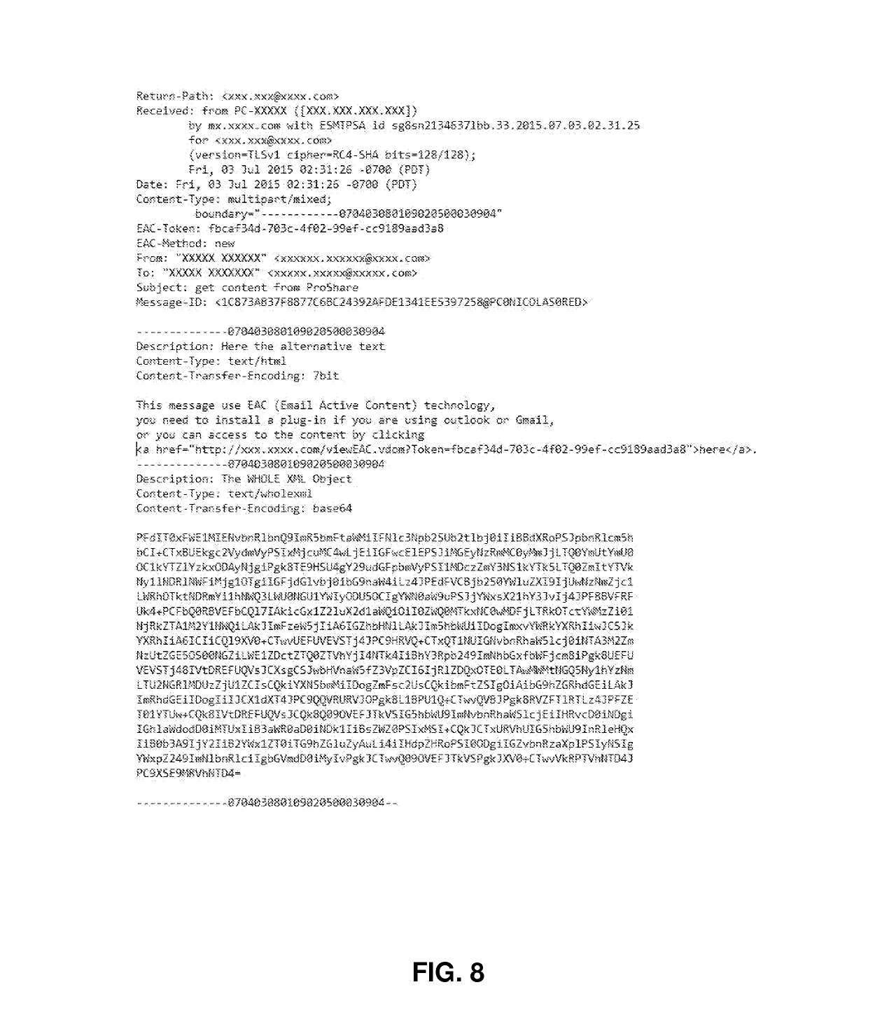

FIG.2 illustrates an example of structure of an EAC email 200, in accordance with one or more implementations. FIG. 2 shows an EAC email 220 including a header section 230, an active content section 250, and a signature section 260. In this example, the email generation software will build an ASCII text compliant with email specifications (an example of an ASCII text compliant with email specifications is shown in FIG. 8). The email may be sent normally via a standard SMTP server 192 (FIG.1; FIG. 3) and received by a usual mailbox (POP server 194, FIG.1; FIG. 3) accessible with email client software using standard protocol (e.g., POP3 or IMAP4) via network 198 (FIG.1).

In the example illustrated in FIG. 2, modification of the existing email infrastructure is not needed. The email content may comply with EAC email structure while respecting the existing standards. The header section 230 of the EAC email 220 may include at least two fields named here “EAC-Token” 234, and “EAC-Method” 236. The header section may provide the email client software with information related to the EAC email 220. For example, EAC-Token 234 provides a unique identifier related to an instance of EAC email 220. EAC-Method 236 may provide one or more instructions. The one or more instructions may include an instruction “New”, an instruction “Update”, and/or an instruction “Delete”. Instruction “New” may inform the client software that this email is a new instance defined by its EAC-Token. Instruction “Update” may inform the software that it must replace all instance of email with the same EAC-Token provided by this email. In some embodiments, instruction “Update” may instruct the client software to delete old email instances. Instruction “Delete” may instruct the client software to delete email with the EAC-Token provided including EAC email 220. The header section 230 of the EAC email 220 may facilitate control of the behavior of individual email referenced with the unique identifier EAC-Token. A parallel example, could be an example of a software operation on an operating system, it allows installing, updating and deleting an “EAC Application”.

In some implementations, the one or more hardware processors are further configured to include a web link to the one or more user interfaces being transmitted. For example, section 240 of EAC email 220 may present the user with an alternative message in the case the user email client is not EAC enabled (e.g., FIG. 8). In other words, the EAC technology does not exclude users by proposing in a method to read the content encapsulated in the EAC email. The user experience, however, depends on the compliance of the user client software with the EAC Technology.

Active content section 250 may be as some MIME type like application/xml for a generic one or as shown on FIG. 8 text/wholexml for a more universal implementation a MIME type would be later chosen. The active content may include the needed data to connect to the EAC Logic server. The information will be similar to an envelope of the initial User Interface definition that is the main active content.

In some implementations, signature section 260 may facilitate incorporation of an optional digital signature of the content to preserve the integrity of the content from external manipulation and provide information about the content origin.

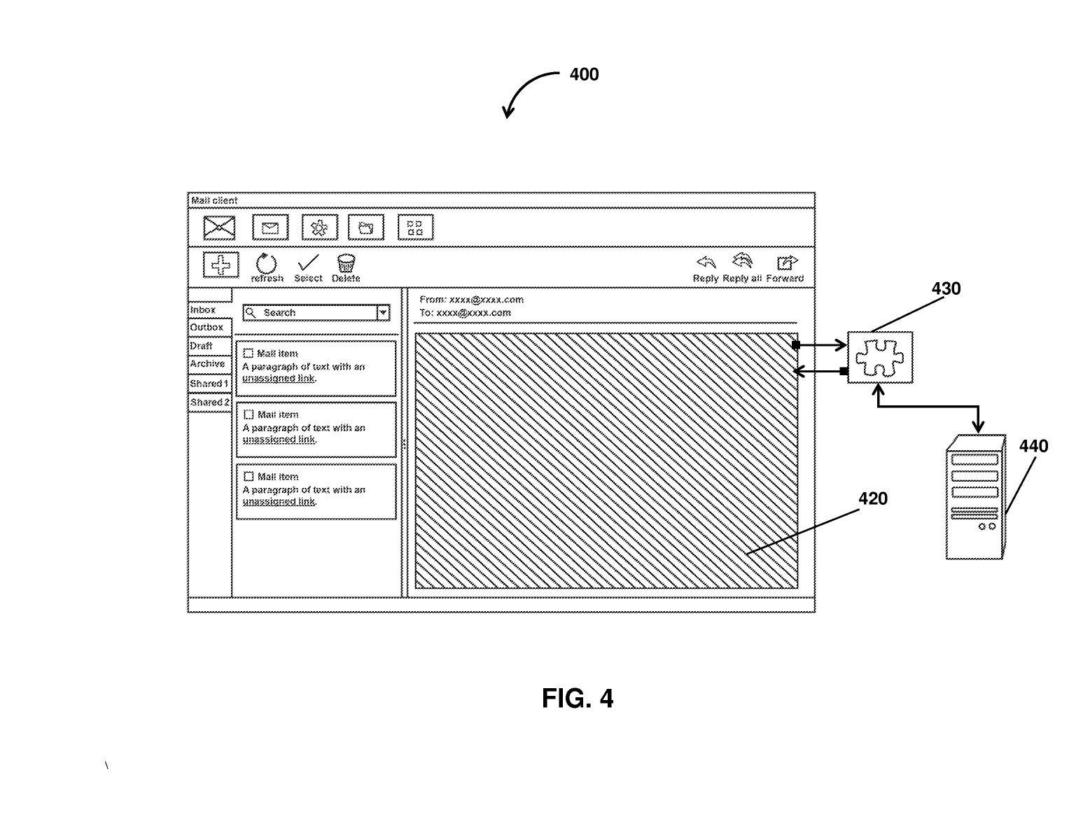

Referring back to FIG. 1, rendering component 160 may be configured to render the active content. In some implementations, the rendering may be a full featured rendering. In some implementations, the active content may be fully integrated into the client software. In some implementations, the active content may be dynamically rendered. For example, FIG. 4 illustrates a rendering process 400 of the user interface. Rendering process may be embedded in the EAC Processor software 430, and/or processed by EAC logic server 440. In some implementations, EAC Processor 430 may send to the EAC logic server 440 the active content to be rendered into a format that the email client rendering software container 420 may be able to render internally (e.g., HTML or HTML+JavaScript). In some implementations, when “EAC Full”, rendering software container 420 may be able to catch the user events and send them via the EAC Processor 430 to the EAC Logic server 440 to be processed and if needed to generate a new user interface that will be sent as an answer to the events transmitted.

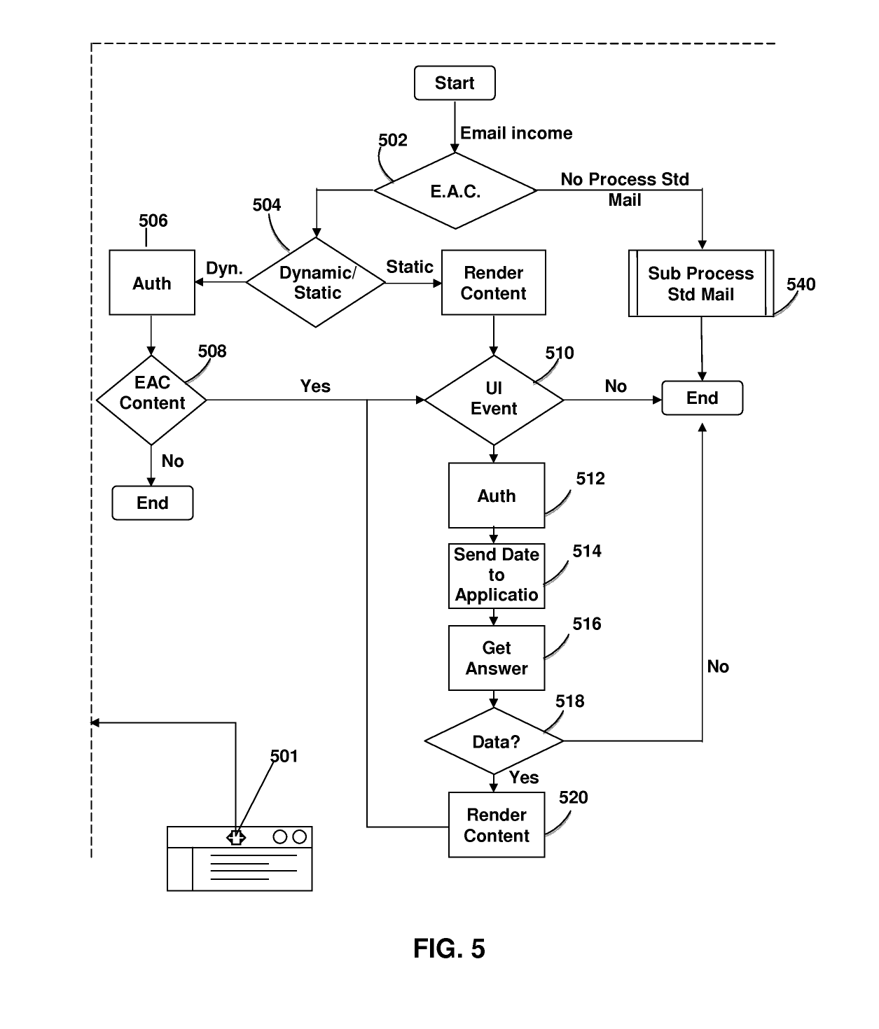

In some implementations, the active content may be dynamically rendered. For example, FIG. 5 illustrates a processing flow diagram 500 by the EAC software component when the EAC full method is applied. In some implementations, the client may launch the EAC email processing 502 as shown in FIG. 5. If the EAC email is set to dynamic content, each time the user consults the given email, operations of the flow chart 500 will be performed each time the user go to see another email or close the application and return to read an EAC email. This behavior may allow having up-to-date email content each time the user will consult the EAC email. FIG.5 shows the flowchart 500 of EAC email processing ran by EAC processor 501 when a user selects the EAC email. In operation, after the email is fetched from the email server and the user attempts to read it, the EAC processor 501 determines at 502 if the email is an EAC email or not. If the email is not an EAC email no further processing is performed 540. If the email is an EAC mail, the decoding of the envelope of the active content will tell if the content is static or dynamic 504. A static email means the initial content of the email does not change over time and one single rendering process is needed to show the result to the user. A dynamic email means that content, including the initial content, is downloaded from the EAC logic server each time the user attempts to read the email. In this case, the EAC Processor will try to access, 506, the EAC Logic server and obtain 508 the user interface to render. After this first step, in case the user interface is designed to respond to events from the users the system will wait any action from the user. If an action is performed, the data representing the event 510 is sent 514 after authentication 512 to the EAC logic server. An answer 516 is generated 518 and sent back to the EAC Processor to be rendered again 520 and the cycle continue until the user does not perform any more action or the EAC logic server has nothing to answer.

In some implementations, rendering the active content dynamically may be performed by rendering software included in the client software. In some implementations, rendering the active content dynamically may be performed by a native rendering code embedded in the email client, and/or a plug-in. For example, the rendering process made by the EAC Processor 430 (FIG.4) may convert the serialized description of the user interface (e.g., drawing and event manager) to a full functional user interface, that is part of the main email client software 420 (FIG. 4) without any limitation unlike the usual HTML rendering process of email client.

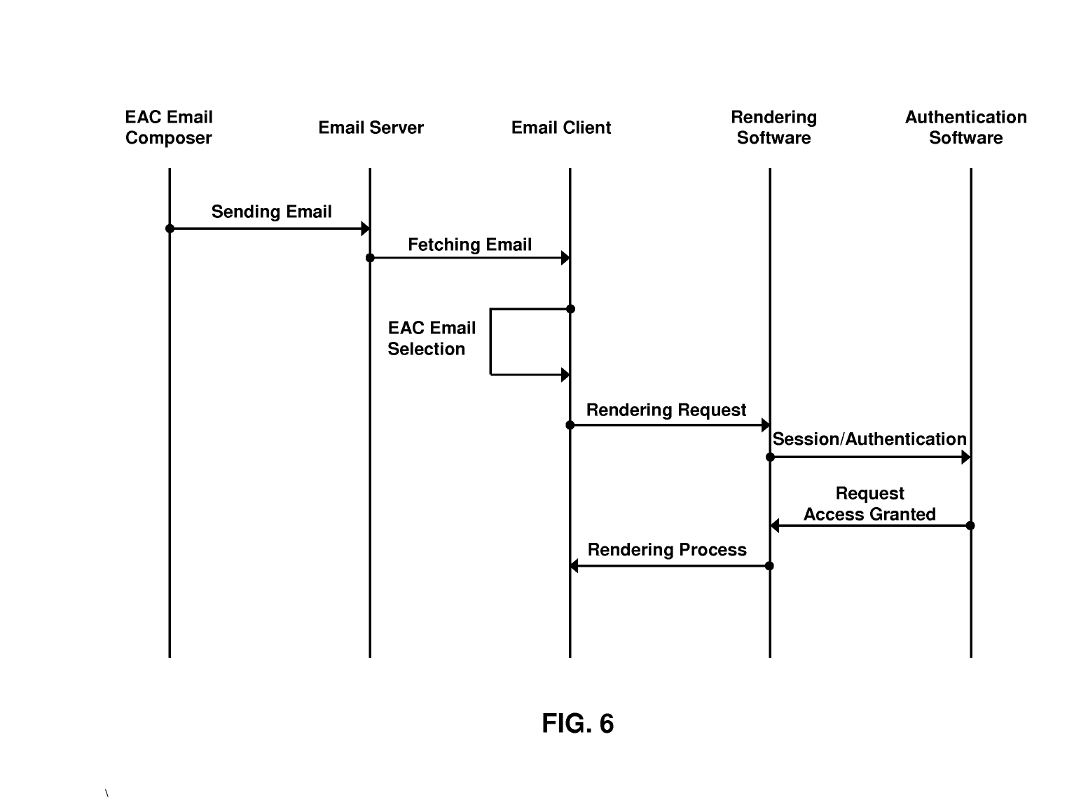

In some implementations, EAC processor is configured to send a user interactions with the one or more user interfaces transmitted by email to the rendering server such that the next time the receiving client email accesses the received email message, the rendering server updates the instance of the one or more user interfaces in the received email. In some implementations, the one or more user interfaces transmitted by email changes dynamically overtime. The EAC processor may be configured to send updates to the rendering server such that the next time the receiving client email accesses the received email message, the rendering server updates the instance of the user interface sent by email attached to the EAC software application in the received email. In some implementations, in order to make the content of the email fully interactive a process of catching the events of the content may be generated by the user. The process may be generated by interacting with the user interface and may be implemented in the EAC Processor. The events processed by the EAC Processor may either modify the user interface locally or the events may be sent to the EAC logic server as a serialized description. The EAC logic server may be in charge of computing a new user interface that may be returned to the EAC Processor as a new serialized user interface. The new serialized user interface may be rendered into the client according to the flowchart 500 of FIG. 5. In some implementations, in order to secure the transmission between the EAC Processor rendering system and the server, all communications are initiated by the EAC Processor and require an authentication procedure (e.g., FIG. 6) using any technology allowing to perform the authentication. Examples of technologies for performing authentication may include: ProAdmin Auth, OAuth, Open ID, SAML, and/or other technologies.

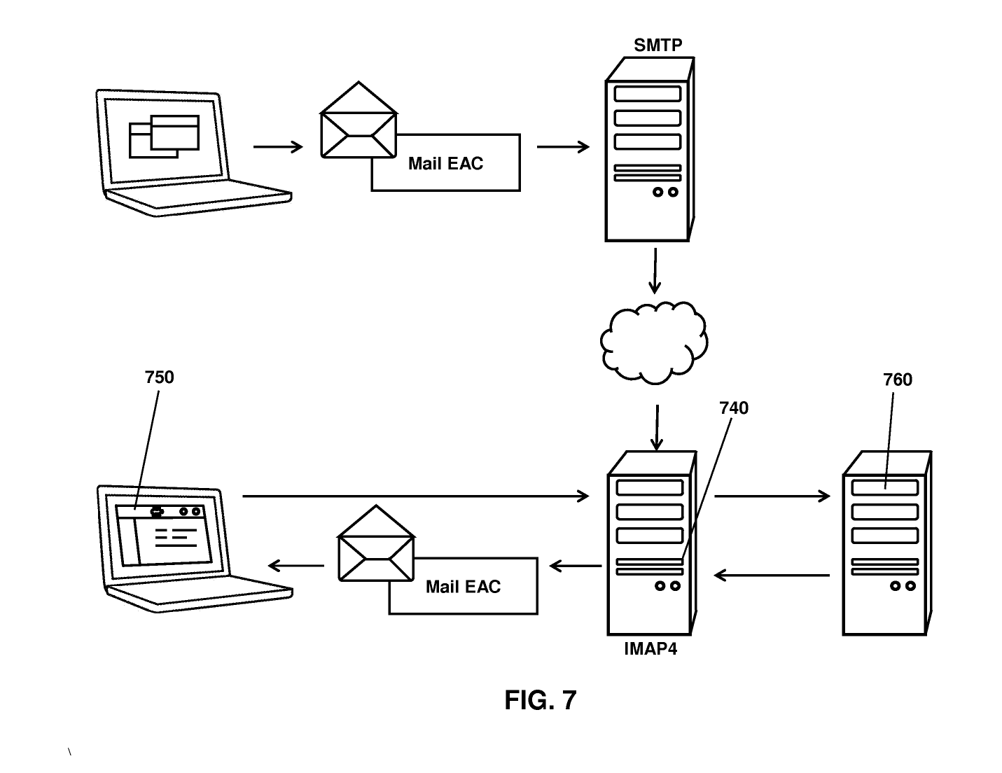

In some implementations, rendering the active content may be static and performed by rendering software that is outside the client software. The rendering software may be configured to convert the user interface into an HTML format. In some implementations, a static email means that its initial content does not change over time and one rendering process is needed to show the result to the user. For example, FIG. 7 illustrates external processing of EAC emails. In this example, the software in charge of rendering the serialised user interface is external software 760 configured to connect to mail box server 740. Mail box 740 stores the messages via a standard protocol (e.g., IMAP4) allowing retrieval and update of the message directly on the server. The task of external software 760 may be to modify the message stored in the Mail Box server 740 to a message that can be rendered by usual email client software 750. External software 760 may modify the serialized user interface into HTML up to the limit permitted by email client software 750. The rendering described in FIG.7 is a degraded rendering process of the user interface that is not interactive due to the limitation of standard email client software. This mode allows seeing an EAC content if the user is not using email client software that implements internally an EAC Processor.

In some implementations, the EAC processors 120 may be further configured to serialize the user interface that includes the active content to be transmitted by converting the user interface into a form that can be transmitted. Serialization of the user interface may be performed in any technology allowing the serialization. By way of non-limiting example: VDOM XML, XAML, XUL, and/or other technologies. The EAC processors 120 may be configured to obtain one or more attributes that enables communication and authentication with the EAC logic server. Examples of attributes may include: Attributes of the authentication (e.g., integrated when using ProAdmin Auth, or external when using an external technology for authentication), attributes of a session token may be GUI D (a token to guarantee the session), attributes of the content type may include static content and/or dynamic content, attributes of the server (e.g., DNS name that holds the logic), attributes of the VDOM Application (e.g., GUI D unique identifier of the application that holds the logic), attributes of platform system account (e.g., user, password), attributes of the API endpoint (e.g., Container API/method) to get the serialized User Interface in case of dynamic content, attributes of the API endpoint to post event data to the EAC Logic server (e.g., Container API/method), and/or other attributes.

The EAC logic server may be configured to process client-server events. The EAC processors 120 may be configured to encapsulate in a standard email format the serialized user interface and the attributes. Such encapsulation may be performed using MIME extensions. The email generated may be fully supported by usual email infrastructure (FIG. 3).

Returning to FIG.1, EAC processor(s) 120 may be configured to provide information processing capabilities in system 100 (e.g., in server(s) 110). EAC processors may include one or more hardware processors. As such, EAC processor(s) 120 may include one or more of a digital processor, an analog processor, a digital circuit designed to process information, an analog circuit designed to process information, a state machine, and/or other mechanisms for electronically processing information. Although EAC processor(s) 120 is shown in FIG. 1 as a single entity, this is for illustrative purposes only. In some implementations, EAC processor(s) 120 may include a plurality of processing units. These processing units may be physically located within the same apparatus (e.g., in server(s) 110), or EAC processor(s) 120 may represent processing functionality of a plurality of apparatuses operating in coordination (e.g., in server(s) 110).

Electronic storage 112 may comprise electronic storage media that electronically stores information. The electronic storage media of electronic storage may include one or both of system storage that is provided integrally (i.e., substantially non-removable) with server(s) 110 and/or clients 190, and/or 196, and/or may contain removable storage that is removably connectable to server(s) 110 and/or clients 196 and/or 196 via, for example, a port or a drive. A port may include a USB port, a firewire port, and/or other port. A drive may include a disk drive and/or other drive. Electronic storage 112, may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 112 may include one or more virtual storage resources (e.g., cloud storage, a virtual private network, and/or other virtual storage resources). Electronic storage 112 may store digital media items, software algorithms, information determined by EAC processor(s) 120, information received from server 110, and/or clients 190 and/or 196, and/or other information that enables server 110 and/or clients 190 and/or 196 to function as described herein.

Clients 196 (and/or client 196) may include a user interface, electronic storage, one or more processors, and/or other components. The user interface may be configured to provide an interface between system 100 and a user through which the user may provide information to and receive information from system 100. This enables information, results, and/or instructions and any other communicable items, collectively referred to as “information”, to be communicated between the user and one or more components of system 100. Examples of interface devices suitable for inclusion in the user interface include one or more of a keypad, buttons, switches, a keyboard, knobs, levers, a display screen, a touch screen, speakers, a microphone, an indicator light, an audible alarm, a printer, and/or other devices. In some implementations, the user interface may include a plurality of separate interfaces, including an interface that may be provided in server(s) 110, and a separate interface provided to view and/or manage stored information that has been retrieved from server(s) 110 (e.g., provided by a computer configured to receive information from server(s) 110 and other components of system 100).

The external resources 195 may include sources of information, hosts and/or providers of information outside of system 100, external entities participating with system 100, and/or other resources. In some implementations, some or all of the functionality attributed herein to external resources 195 may be provided by resources included in system 100 (e.g., in server(s) 110).

The network 198 may include the Internet and/or other networks, Intranets, near field communication, frequency (RF) link, Bluetooth®, Wi-Fi, and/or any type(s) of wired or wireless network(s). It will be appreciated that this is not intended to be limiting and that the scope of this disclosure includes implementations in which the server(s) 110, and/or the external resource(s) 195, are operatively linked via some other communication media.

It should be appreciated that, although components 140,150, and/or 160 are illustrated in FIG. 1 as being co-located within a single component, in implementations in which processor 120 is configured by machine-readable instructions 130 to execute multiple components, one or more of components 140,150, and/or 160 may be located remotely from the other components. The description of the functionality provided by the different components 140,150, and/or 160 described above is for illustrative purposes and is not intended to be limiting, as any of components 140,150, and/or 160 may provide more or less functionality than is described. For example, one or more of components 140,150, and/or 160 may be eliminated, and some or all of its functionality may be provided by other ones of components 140,150, 160, and/or other components. As another example, processor 120 may be configured by machine-readable instructions 130 to execute one or more additional components that may perform some or all of the functionality attributed below to one of components 140,150, and/or 160.

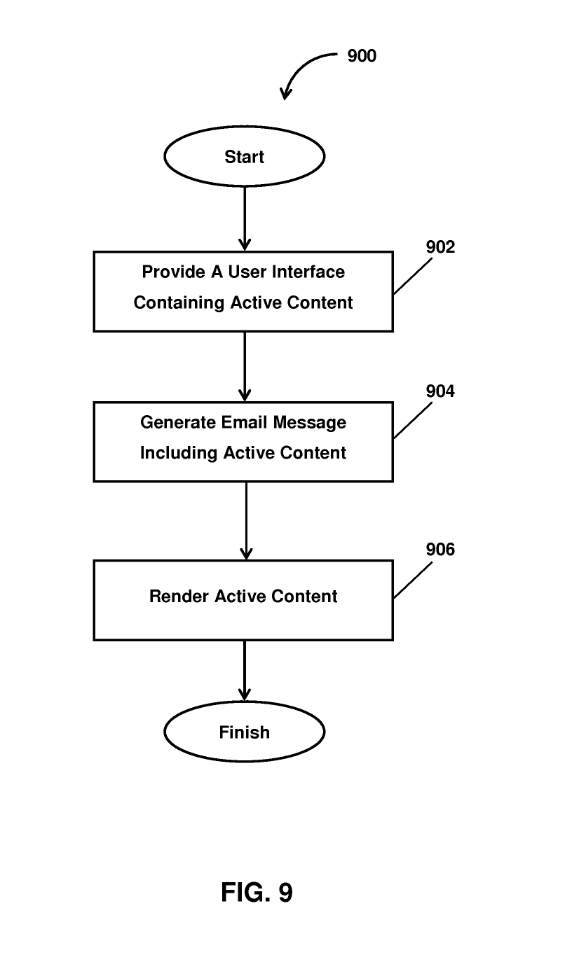

FIG. 9 illustrates a method 900 for creating and transmitting active content via electronic messaging. The operations of method 900 presented below are intended to be illustrative. In some embodiments, method 900 may be accomplished with one or more additional operations not described, and/or without one or more of the operations discussed. Additionally, the order in which the operations of method 900 are illustrated in FIG. 9 and described below is not intended to be limiting.

In some embodiments, method 900 may be implemented in one or more processing devices (e.g., a digital processor, an analog processor, a digital circuit designed to process information, an analog circuit designed to process information, a state machine, a functionally limited processing device, and/or other mechanisms for electronically processing information). The one or more processing devices may include one or more devices executing some or all of the operations of method 900 in response to instructions stored electronically on an electronic storage medium. The one or more processing devices may include one or more devices configured through hardware, firmware, and/or software to be specifically designed for execution of one or more of the operations of method 900.

At an operation 902, a user interface including the active content to be transmitted may be provided. In some implementations, operation 902 may be performed by a user interface component the same as or similar to user interface component 140 (shown in FIG. 1 and described herein).

At an operation 904, an email message including the active content may be generated. In some implementations, the email message may be generated in response to user-interactions with the user interface. In some implementations, the email message may include a header including a unique identifying token field and an instructions field. In some implementations the instructions field may have one or more instructions. In some implementations, the unique identifying token field may include a unique identifying token. The unique identifying token may be a unique identifier associated with the email message. In some implementations, the one or more instructions may be configured to control a behavior of individual instances of the email having the unique identifying token. In some implementations, the one or more instructions may include an instruction “new” informing client software that an instance of the email message is a new instance defined by the unique identifying token. In some implementations, the one or more instructions may include an instruction “update” instructing the client software to replace individual instances of the email having the same unique identifying token. In some implementations, the one or more instructions may include an instruction “delete” instructing the client software to delete individual instances of the email having the same unique identifying token including the email message. Operation 904 may be performed by an email generation component the same as or similar to email generation component 150 (shown in FIG. 1 and described herein).

At an operation 906, the active content may be rendered. In some implementations, rendering may be a full featured rendering. In some implementations, the active content may be dynamically rendered. In some implementations, operation 906 may be performed by a rendering component the same as or similar to the rendering component 160 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for generating and transmitting an email message including an active content, the active content being a user interface describing a unique instance of a software application, the system comprising:
one or more hardware processors configured by machine-readable instructions to:
obtain the user interface to be transmitted by the email message;
attach access information to the email message, the access information configured to facilitate access to a rendering server, the rendering server configured to render the user interface being transmitted by the email message in a format that is compatible with a receiving email client;
generate a header for the email message, the header including a unique identifying token, the unique identifying token being a unique identifier associated with the user interface being transmitted; and
transmit the email message to the receiving email client, wherein responsive to receiving the email message, the receiving email client is configured to connect to the rendering server using the access information included in the email message, and wherein the rendering server is configured to render the user interface in a format that is compatible with the receiving email client.

2. The system of claim 1, wherein the header comprises one or more instructions configured to provide instructions associated with the unique identifying token to the rendering server, the instructions including:
an instruction “new” informing the rendering server that the instance of the user interface included in the email message is a new instance;
an instruction “update” instructing the rendering server to update the instance of the user interface identified by the unique token with the instance included in the email message; and
an instruction “delete” instructing the rendering server to delete the instance of the user interface identified by the unique token.

3. The system of claim 1, wherein the one or more hardware processors are further configured to send a user interactions with the user interface transmitted by email to the rendering server, wherein the next time the receiving client email accesses the received email message, the rendering server is configured to update the instance of the user interface sent by email attached to the EAC software application in the received email.

4. The system of claim 1, wherein the user interface of the software application transmitted by email changes dynamically overtime, and wherein the one or more hardware processors are further configured to send updates to the rendering server, wherein the next time the receiving client email accesses the received email message, the rendering server is configured to update the instance of the user interface in the received email.

5. The system of claim 1, wherein the one or more hardware processors are further configured to generate a digital signature that provides information related to the origin of the email message.

6. The system of claim 1, wherein the one or more hardware processors are further configured to include a web link to the user interface being transmitted.

7. A method for generating and transmitting an email message including an active content, the active content being a user interface describing a unique instance of a software application, the method being implemented in a system including one or more hardware processors configured by machine-readable instructions to execute the method, the method comprising:
obtaining the user interface to be transmitted by the email message;
attaching access information to the email message, the access information configured to facilitate access to a rendering server, the rendering server configured to render the user interface being transmitted by the email message in a format that is compatible with a receiving email client;
generating a header for the email message, the header including a unique identifying token, the unique identifying token being a unique identifier associated with the user interface being transmitted; and
transmitting the email message to the receiving email client, wherein responsive to receiving the email message, the receiving email client is configured to connect to the rendering server using the access information included in the email message, and wherein the rendering server is configured to render the user interface in a format that is compatible with the receiving email client.

8. The method of claim 7, wherein the header comprises one or more instructions configured to provide instructions associated with the unique identifying token to the rendering server, the instructions including:
an instruction “new” informing the rendering server that the instance of the user interface included in the email message is a new instance;
an instruction “update” the rendering server to update the instance of the user interface identified by the unique token with the instance included in the email message; and
an instruction “delete” instructing the rendering server to delete the instance of the user interface identified by the unique token.

9. The method of claim 7, further comprising sending a user interactions with the user interface transmitted by email to the rendering server, wherein the next time the receiving client email accesses the received email message, the rendering server is configured to update the instance of the user interface in the received email.

10. The method of claim 7, wherein the user interface transmitted by email changes dynamically overtime, and wherein the method further comprises sending updates to the rendering server, wherein the next time the receiving client email accesses the received email message, the rendering server is configured to update the instance of the user interface in the received email.

11. The method of claim 7, further comprising generating a digital signature that provides information related to the origin of the email message.

12. The method of claim 7, further comprising including a web link to the user interface being transmitted.
